(19) United States
(12) Patent Application Publication
(10) Pub. No.: US 2015/0088305 A1
(43) Pub. Date: Mar. 26, 2015

(54) METHOD AND DEVICE FOR COMMUNICATING WITH VENDING MACHINE

(71) Applicant: DATAVEND LTD., Sofia (BG)

(72) Inventor: Stefan Georgiev Tsenev, Sofia (BG)

(21) Appl. No.: 14/397,474

(22) PCT Filed: Apr. 22, 2013
(86) PCT No.: PCT/BG2013/000017

§ 371 Date: Oct. 27, 2014

(30) Foreign Application Priority Data
Apr. 25, 2012 (BG) 111201

(51) Int. Cl. G07F 11/00; G07F 9/02; H04L 29/06; G07F 5/18; G06Q 10/00; H04L 29/08

(52) U.S. Cl. CPC G07F 11/002; G06Q 10/20; H04L 67/12; H04L 69/08; G07F 5/18; G07F 9/026
USPC 700/236; 700/244

(57) ABSTRACT

Invented method comprises data detection by watching communication between vending machine and its payment system in unified manner, without intervention in this communication, and automated downloading this data; transmitting downloaded data via wireless network by invented device's modem/external peripheral device's resource; analyzing this data by determining events and one-time events and generating states by unifying the meaning of communication between vending machine and its payment systems performed according to multitude of standard communication protocols; extracting from analyzed data of information about technical condition of vending machine/payment systems, about operating regime of vending machine, about sales made by vending machine and revenues in its payment systems; remote control on basis of analyzed data and optional discontinuation/restoration of vending machine operation by invented device at request by external peripheral device connected to vending machine. The data is tracked or monitored and the diagnosis at the vending machine is transferred.

### TECHNICAL FIELD

The present invention relates to a method and device for communicating with a vending machine with the purpose to obtain data regarding the technical condition, sales and servicing the vending machine and its payment system(s).

### BACKGROUND OF THE INVENTION

The automations for selling goods or services (vending machines) are known since a long time and nowadays are widely distributed in the whole world. The fact that such vending machines are offered by many companies from different countries inevitably leads to a great diversity of the offered vending machines, their software and communication protocols controlling the communication between the vending machine and its payment system. It is very important for the optimization of the operation of the vending machine to have a remote access to the information regarding its sales and technical condition in a real time. Having such information at ready disposal would allow a quick and timely action in case of malfunction, control of the personnel and optimization of the maintenance of the vending machine. The lack of unified method for determination and remote collection of information about the sales and technical condition of the vending machine, the said method being readily integrated into the present vending machines, is a major problem and there exists in the concrete technical field the urgent necessity to solve this problem.

The greater part of the used vending machines for selling goods or services use several different protocols for communication between the vending machines and the payment systems of these vending machines, and namely:

### MDB/ICP—NAMA Multi-Drop Bus/Internal Communication Protocol;

### Protocol A—MEI 20 mA Protocol A Specification;

### BDV—Protocol A, BDV 001 Branch;

Parallel Validator 14 VDC, Parallel Validator 24 VDC—single/multi-vend parallel interfaces.

Other protocols and interfaces that are not so popular are different types of electro-mechanical interfaces and the MICROMECH protocol.

There exist protocols for downloading of data from the control logic of the vending machine pertaining to the sales and operating regime of the vending machine according to the standard EVA-DTS: EVA-DTS DDCMP and EVA DTS DEX/UCS. Both protocols require their implementation in the control logic of the vending machine as well as implementation in the hardware design at factory level. Furthermore they encompass the part relating to downloading of data but do not address the problem with the subsequent transfer of this data. EVA-DTS DEX/UCS is popular mainly in North America, while EVA-DTS DDCMP is popular mainly in Europe. As a significant conceptual difference between them could be pointed out the fact that in the standard DDCMP (unlike DEX/UCS) there does not exist the condition requiring the fully automated download of data and furthermore in DDCMP it is not possible to download data in case the controller of the vending machine is engaged with some other functions. On grounds of these main characteristics of both protocols the conclusion could be made that they do not satisfy the criteria for a generally valid method for collecting data from vending machines, because of the following reasons:

These protocols require their implementation at factory level and in view of their advisable character these protocols are not used by all producers;
These protocols do not address the problem with the transfer of the downloaded data to a central location;
Their geographic distribution is limited;
These protocols contain additional limitations impeding the automated download of data.

In the present invention these protocols are used to obtain additional information regarding the already determined events in the vending machines where these protocols are present and therefore the method and device according to the present invention are not hindered by the aforementioned limitations.

Part of the above mentioned protocols standardized by EVA (European Vending Association) and NAMA (National Automatic Merchandising Association) contain commands for control of an auditing module but because of the advisable character of these standards they are very rarely implemented in their complete form. This necessitates the use of a novel approach to the collection of information about the sales and technical condition of vending machines like collection of data by means of watching over the communication between the vending machines and their payment systems. On its part this requires that a unified logic is built for the determination of the events occurring in the vending machines.

EP 1 020 822 A1 discloses a control system for vending machines using unification of the control logic in the vending machine. This presupposes intervention and amendment of the existing logic of the vending machines which complicates the solution and makes it expensive. Furthermore the disclosed technical solution develops the principle of centralized data collection using an optical network as transport medium. The present invention does not require any intervention and amendment of the existing logic of the vending machines but offers a novel approach for the unification of the sales data by means of watching the communication between the vending machines and their payment systems. Furthermore the present invention presupposes data transfer using an already existing wireless mobile network which significantly simplifies the implementation of the approach.

U.S. Pat. No. 6,250,452 B1 describes a control system for vending machines having an integrated payment system connected therewith by means of the so called “electro-mechanical interface” (according to the definition of the European Vending Association described in the document “Overview of Vending Machine Interface 2012” published on the Internet site of EVA htpp://www.vending-europe.eu/standards-and-protocols/overview-of-vending-machine-interface_{—}2012.pdf). In this document is disclosed the principle of collecting data and recording it in a local device integrated into the vending machine and the transfer of this data to another, remote device. It should be noted that in the said patent no mention is made about the manner of data transfer but only the concept of centralized collection of data is discussed. One embodiment of the present invention encompasses data collection by watching this interface as well.

U.S. Pat. No. 6,322,262 B1 discloses control system for vending machine selling printed matter having an integrated payment system for coin validation and a control system. The proposed technical solution is applicable to limited types of vending machines with a concrete payment system which necessitates the remodeling of the existing logic of other types of vending machines with other types of payment systems. Besides, the proposed solution requires that a personal computer is used as a main control of the vending machine and collection and storage of statistical data in this personal computer before their transmission to a centralized location. This is not necessary in the device according to the invention.

U.S. Pat. No. 6,772,048 B1 describes a system for remote control of automats built of control modules transmitting data in a wireless network to a central machine collecting data which on its part transmits this data to an external device or to a central location. The described system presupposes that new control logics for vending machines are designed that are able to support the functions described in the said invention or that such new logics are integrated into the vending machines already at the production stage thereof. The so called “host controller interface driver” (FIG. 4, 52) and “transport layer” (FIG. 4, 54) or similar elements are integrated into very small number of vending machines. As similar standards could be mentioned the standards for control of vending machines standardized by EVA (European Vending Association)—EVA-DTS DDCMP and EVA-DTS DEX/UCS. Even if this condition is fulfilled this is not sufficient to obtain a general applicability of the said technical solution because the first standard does not provide for the possibility of automated data download. Besides, the disclosed invention requires the presence of a central machine collecting data which complicates this solution and makes it expensive.

In contrast to the above described approach the present invention does not require the use of any specialized intelligent modules but it uses the information exchanged between the vending machine and the standard payment systems thereof studying this information without any intervention, with the purpose to determine events relating to sales and operating regime of the vending machine. The necessity of a central machine is removed as well and all data is transmitted directly to a central location using as transport medium an already existing wireless mobile network (GSM network).

US 2010/0176197 A1 discloses a system for validation of bank notes with integrated card reader for non-cash payments. The invention does not relate to sales control and control of the condition of the vending machine in cases where other types of payment systems are connected to the vending machine.

The above presented technologies do not offer any approach by means of which it is possible to collect information about the sales and technical condition of vending machines and their payment systems without any limitations as to the types of their interfaces, their producer or model or any necessity of human intervention in the process of data collection and data transfer to a location where the data collected from a number of vending machines could be processed.

### ESSENCE OF THE INVENTION

The present invention provides a method and device intended to unify the data from widely used protocols for communication between a vending machine and its payment system (MDB, Protocol A, BDV, Parallel Validator 12 VDC, Parallel Validator 24 VDC) and other, not so popular protocols—MICROMECH and Protocol for electro-mechanical interface as well as to unify the data defined according to the standard EVA-DTS for auditing of vending machines, to determine events on grounds of this data and to transmit this data to a remote server using its own GSM modem or modem that is a resource of a peripheral device.

The method according to the present invention comprises detection of data by watching the communication between a vending machine and its payment system in unified manner, without any intervention in this communication, and automated download of this data; transmission of the downloaded data in a wireless network by means of a modem representing a resource of the device according to the present invention or a resource of an external peripheral device; carrying out of analysis of the detected and transmitted data by means of determination of events and one-time events and generating states using unification of the meaning of the communication between the vending machine and its payment systems conducted according to a multitude of standard communication protocols; extraction from the analyzed data of information about the technical condition of the vending machine, about the technical condition of the payment systems, about the operating regime of the vending machine, about the availabilities in their payment systems, the sales made by the vending machine and the revenues in their payment systems; carrying out of remote control on grounds of the analyzed data and optional discontinuation and restoration of vending machine operation by the device according to the invention at a request sent by an external peripheral device connected to the vending machine.

The device for communicating with a vending machine according to the invention comprises three parts:

Watching part keeping under observation the data transmitted according to different communication protocols between the payment system and the vending machine, without any intervention on the part of the device according to the invention, the said watching part downloading and systematizing this date automatically;
Unified logic for determination of events and one-time events on grounds of the received and systematized data;
Transmitting part transmitting the received and systematized data and the determined events generating states and the on-time events to a server using the existing GSM network by means of an integrated modem or modem resource of a peripheral device.

### DESCRIPTION OF THE FIGURES

Hereinafter the invention will be clarified in detail with reference to the enclosed drawings on which:

FIG. 1 represents a block diagram of a device according to the invention;

FIG. 2 represents a block diagram of the universal communication module of a device according to the invention serving as connection to a vending machine and its payment system.

FIG. 3 represents a block diagram of the common logic of a device according to the invention handling data and events.

FIG. 4 represents a block diagram of the logic for handling data from the universal module for communication with a device according to the invention.

FIG. 5 represents an algorithm for generating states in accordance with the method of the invention.

FIG. 6 represents an algorithm for handling events related to revenues and sales of the vending machine.

FIG. 7 represents an algorithm for communicating between a device according to the invention and a peripheral device.

FIG. 8 represents a connectivity diagram for general application of a number of devices according to the invention.

### EMBODIMENTS OF THE INVENTION

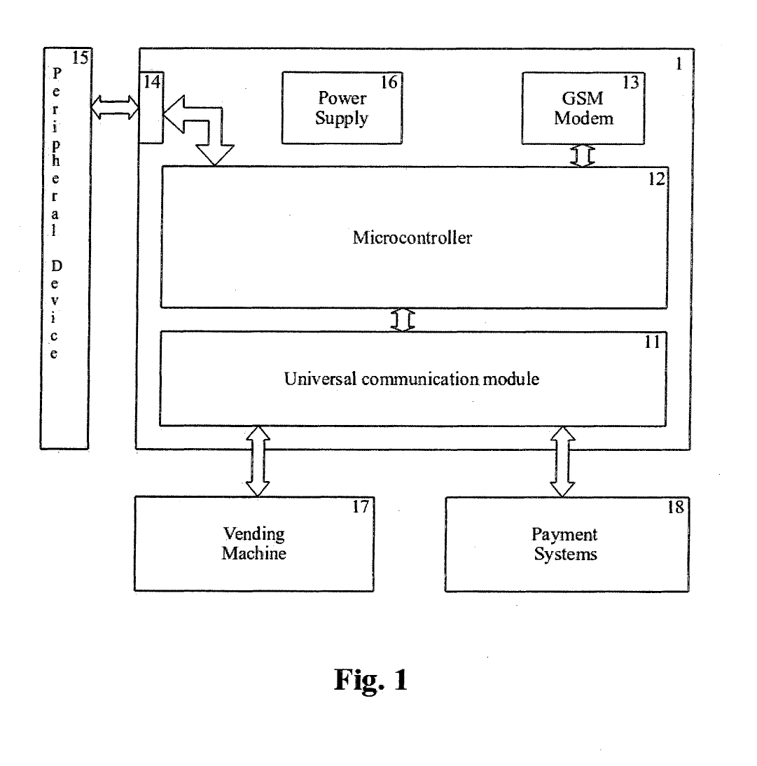

FIG. 1 represents a block diagram of device 1 according to the invention. Device 1 comprises a universal module 11, a microcontroller 12, an integrated GSM modem 13, a port 14 for communication with an external peripheral device 15 and a power supply unit 16.

Universal communication module 11 makes connection with a vending machine 17 and payment systems 18 by means of communication protocols standardized for connection between these types of devices.

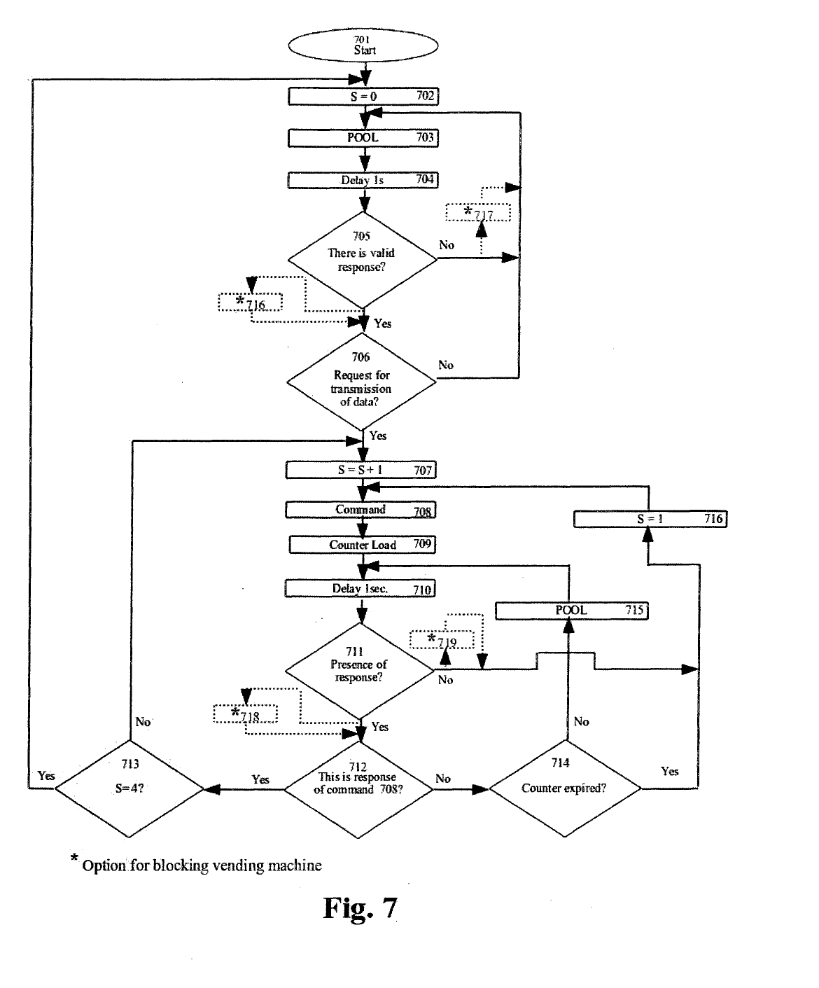

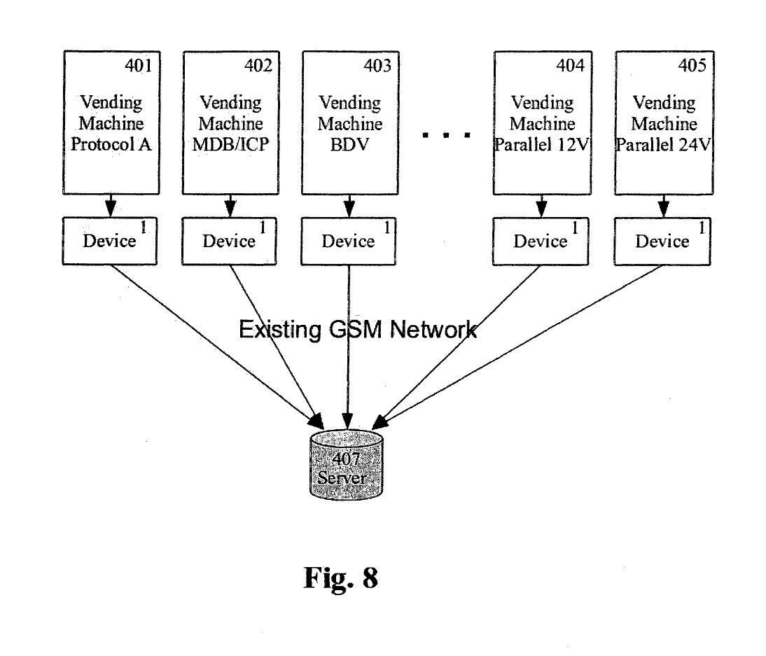

Microcontroller 12 carries out logical functions for monitoring the interfaces, processing the events and defining certain states corresponding to these events, initiating the transmission of these states to a server 407 (shown on FIG. 8—general application) by means of an integrated GSM modem 13 and supporting the communication protocol for communication with an external device 15. The communication between the device 1 and the external peripheral device 15 is carried out by means of RS232 interface according to a preassigned algorithm according to FIG. 7.

Microcontroller 12 also memorizes automatically the data downloaded by the watching part and stores it in a memory that may be integrated in the device 1 or may be an external memory connected to the device 1.

In one embodiment of the present invention transmitting data to the server 407 is carried out by the modem of the external peripheral device 15.

The external peripheral device 15 may influence the operating regime of the vending machine sending commands for blocking or unblocking of its operation.

In one embodiment of the invention the resources of the external peripheral device 15 (e.g. a display) are used for visualization of messages.

The power supply unit 16 provides nominal voltages of 5 VDC and 4.2 VDC (if an integrated GSM modem is used).

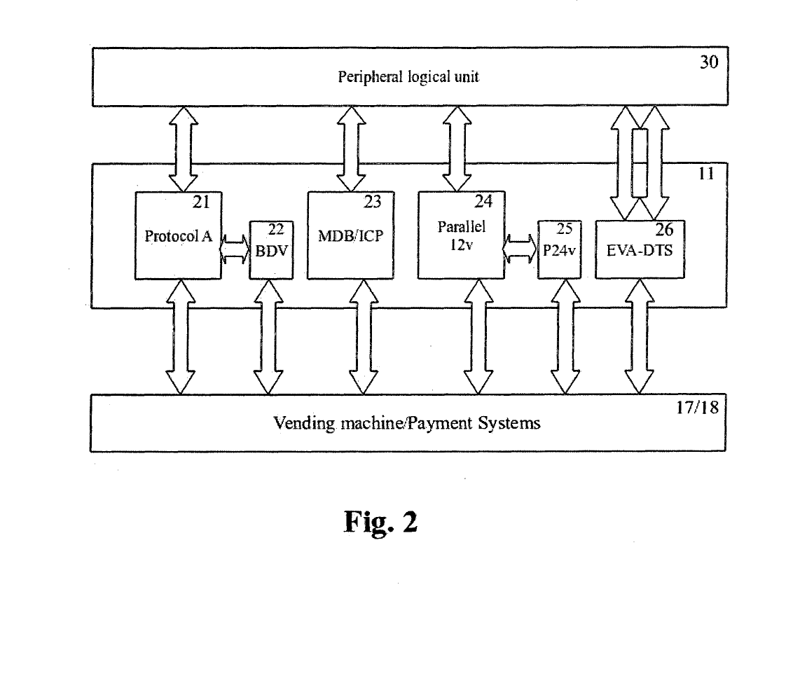

FIG. 2 represents a universal communication module 11 for connection with the vending machine 17 and the payment systems 18. The universal communication module 11 consists of several components for connection by means of different types of communication protocols—an interface module 21 for Protocol A (executive), an interface module 22 for BDV, an interface module 23 for MDB/ICP, an interface module 24 for Parallel Validator 12 VDC, an interface module 25 for Parallel Validator 24 VDC and an interface module 26 for standards EVA-DTS. In one embodiment of the present invention the device 1 has interface modules for connection by means of other standard protocols for communication between the vending machine 17 and its payment systems 18—MICHROMECH protocol and Protocol for electro-mechanical interface.

The interface module 21 for communication protocol Protocol A (executive) consists of optic insulators for communication with a payment system and 20 mA transceiver electric circuit for communication with the vending machine according to the recommendations regarding the design of the electric circuit of the mentioned protocol described in Appendix A, Recommended Hardware Drive.

The interface module 22 for communication protocol BDV is a cable converter to the Protocol A standard.

The interface module 23 for communication protocol MDB/ICP comprises optic insulators for receiving the signals of the vending machine 17 and payment systems 18 according to the recommendations regarding the design of the electric circuit of the said protocol.

The interface module 24 for Parallel Validator 12 VDC consists of detectors for the different communication channels. According to standard the payment system of the Validator type communicates with the vending machine through six channels reading the incoming of a coin or bank note by means of a short impulse (100 ms). The reverse communication is accomplished only by means of one prohibiting channel which, according to its logical level, allows or prohibits the accepting of money. Besides, the vending machine provides power supply to the payment system. The interface module 24 has 8 detectors—one for each of the coin/bank note channels accordingly, one for the inhibiting channel and one for the power supply. They are built of TTL logic or optic insulators in cases where full insulation of the electric circuits is sought. In view of the fact that the inhibiting channel and the power supply voltage levels that are greater than 5 VDC (12-24 VDC), the voltage is reduced to a value that is acceptable for the TTL logic.

The interface module 25 for Parallel Validator 24 VDC is an addition to the interface module 24 for Parallel Validator 12 VDC and it consists of an inverter of the inhibiting channel.

The interface module 26 for the communication protocols according to the EVA-DTS standard consists of a transceiver (e.g. MAX232 with capacitive voltage multipliers (charge pumps) supporting a variable communication rate (2400-115200 bps). The physical connection of the vending machine is done by means of a cable that may be different for the different types of vending machines.

In another embodiment of the invention circuits may be added that support different types of electro-mechanical interfaces and the MICROMECH protocol.

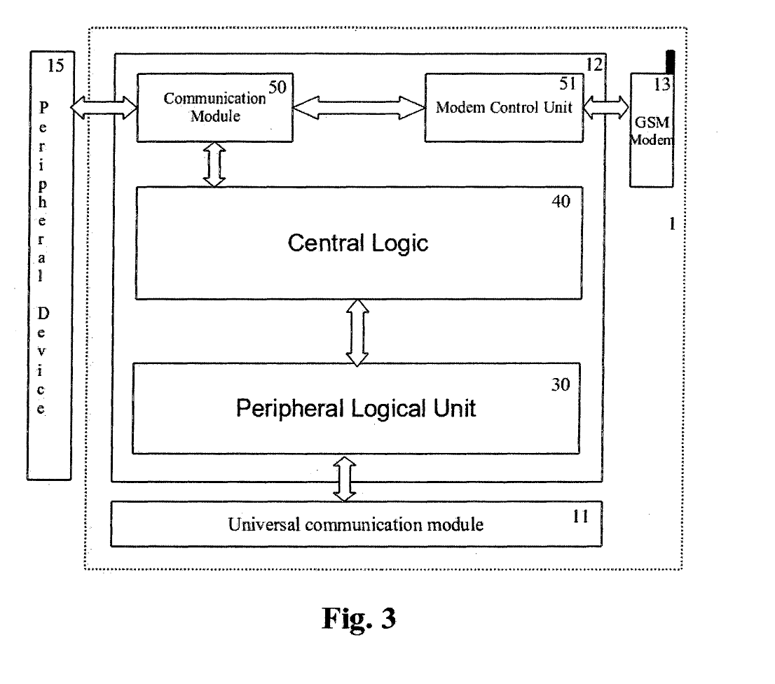

FIG. 3 represents a block diagram of the logic of device 1 according to the invention. The logic carries out the logical handling of the data and events in the microcontroller 12 and consists of: a peripheral logical unit 30, a central logic 40, a communication module 50 and a module 51 for control of a modem.

The peripheral logical unit 30 is responsible for the logical handling of data from the vending machine and the payment system, determining of different types of events and their transmitting to the central logic 40.

The central logic 40 processes all events and determines 3 groups of events according to an algorithm for generating events. The central logic 40 works out a combined state as a combination of several states, in case such are present.

The communication module 50 is responsible for the transmission of the current states and the current values of sales and revenues in certain states, and namely:

When the central logic 40 has generated a change of the state;
When a certain period of time has expired, e.g. 4 hours after the last transmission;
When a request for transmission to a peripheral device is received; When a short text message (SMS) was received with a predetermined content.

The communication module 50 is responsible too for the communication with the peripheral device, performed by means of a protocol whose algorithm is described in FIG. 7 according to the invention.

The module 51 for control of modem carries out the communication with the integrated GSM modem 13 by means of a standard set of AT commands. In the embodiments of the invention in which for communication is used the modem of the external peripheral device 15, a module 51 for control of the modem is not used.

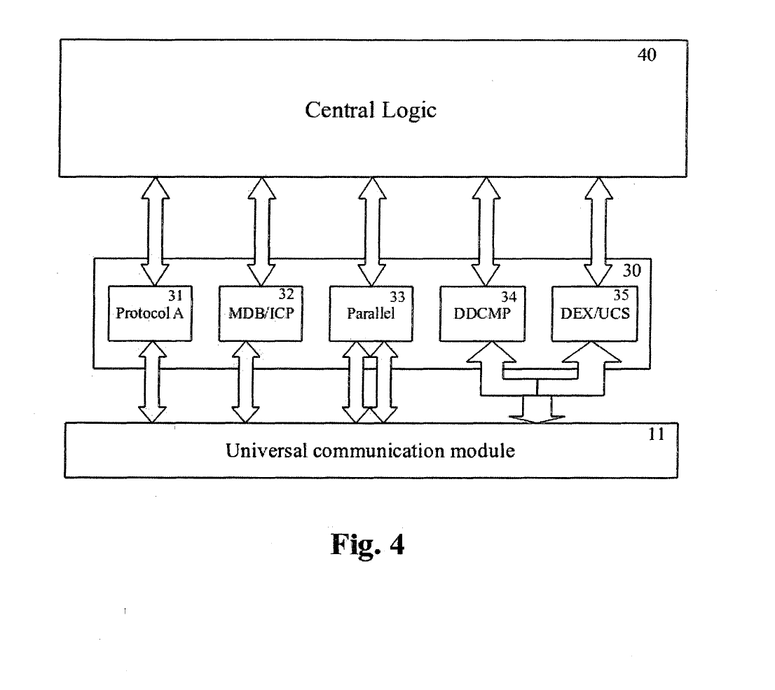

In FIG. 4 is represented a block diagram of the peripheral logical unit 30. The peripheral logical unit 30 consists of sub-modules 31, 32, 33, 34 and 35 handling communication protocols Protocol A (executive) (sub-module 31), MBD/ICP (sub-module 32), Parallel Validator 12 VDC/24 VDC (sub-module 33), EVA-DTS DDCMP (sub-module 34) and DEX/UCS (sub-module 35).

Sub-module 31 for communication protocol Protocol A (executive) receives data transmitted by the vending machine according to this protocol and transmits it to the payment system without any amendment and vice versa—receives the data sent by the payment system to the vending machine and transmits it to the vending machine without any amendment. The sub-module 31 watches for the presence of the commands described in Chapter 4.0 Application Layer of the discussed protocol, and in particular for the commands POOL, CREDIT and VEND and for the transmission of the corresponding responses ACK and BUSY.

The command POOL defines a continuous communication with a maximum period of time of 80 ms between the commands. Delay within 80 ms-10 s may be considered an event related to a technical problem in the payment system 18. Each event of this type as well as other events described hereinafter is sent to the central logic 40 for processing. In response to the command POOL the vending machine 17 sends ACK (if it is ready to operate) or BUSY in case it is not ready to operate. The response BUSY is considered to be an event related to the operability of the vending machine 17. The lack of response is considered to be an event related to the technical condition of the vending machine 17. The command CREDIT determines the condition of the money entering the payment system 18. It is considered to be an event related to the initialization parameters and revenues of the payment system 18. The command VEND determines an event related to a sale made by the vending machine 17.

The sub-module 32 for communication protocol MDB/ICP watches the condition of the transmitting line of the vending machine 17 and for the presence of the commands described in Chapters 5, 6 and 7 of the discussed protocol related to the communication with a coin accepting mechanism, bank note reading device and cashless payment system. The transmitting line of the vending machine 17 watches for presence of a continuous low level and the presence of such a continuous low level determines an event related to the technical condition of the vending machine 17. The initialization commands sent to the payment systems 18 and the corresponding response are considered as an event related to the presence of the initialization parameters of the corresponding payment system. As initialization commands are treated the following commands:

SETUP for coin accepting mechanism;
SETUP for bank note reading device;
SETUP for non-cash payment system (e.g. by means of bank card);

The command POOL determines continuous communication and the lack of such a communication within the period of 80 milliseconds to 10 seconds is considered to be an event related to the operating regime of the vending machine 17 while the lack of response to this command is considered to be an event related to a technical problem in the payment system 18.

An event related to the revenues in the payment system 18 is determined for the different payment systems in the following cases:

for the coin accepting mechanism:
=POOL—Coins Deposited—indication for incoming coin;
=DISPENSE—command to return coins of certain value and type;
=PAYOUT—command to return a certain amount of money for systems supporting Layer2 of the protocol.
for bank note reading device:
=POOL—Bills Accepted—indication for incoming bank note; for cashless payment system:
=VEND—Vend Approved—confirmation of the command VEND with the amount of the corresponding sale;
=REVALUE—supplying the cashless system with credit through the cash payment systems;

Because of the nature of the protocol there is no command determining a single sale.

In this connection a one-time event related to a sale made by the vending machine 17 is defined in the following cases stated in order of priority:

command to return a certain amount of money/coins if there is a credit in the system and provided the credit is larger than the change paid back prohibiting command to accept money if there is credit (COIN TYPE FFh) command to check up the condition of the cartridges of the coin accepting mechanism (TUBE STATUS) if there is credit.

The sub-module 33 for interface Parallel Validator 12 VDC/24 VDC performs detection of a low level of the supply voltage which is considered to be an event related to a technical problem in the vending machine 17.

Detection of high level of the inhibiting channel is considered to be:

event related to the operating regime of the vending machine 17 if there is no credit and power supply is present; event related to a sale made by the vending machine 17 if there is credit.

Detection of low level of the channels of the Validator in case of present power supply is considered to be:

event related to revenues entering the payment system 18 if this level persists for a time interval smaller or equal to 500 ms;
event related to a technical problem in the payment system 18 if this level persists for more than 500 ms.

Sub-module 34 for communication protocol EVA-DTS DDCMP is connected to the integrated port of the vending machine for communication according to this protocol, if such a port is present, if this protocol is supported and if automated auditing by the vending machine is supported, without the necessity to influence directly its operation. In case of detection of an event in accordance with the above described protocols an audit is initiated and the type of the event is determined according to the transmitted data if the vending machine 17 supports the corresponding audit. In such a manner may be determined the following events:

event related to the operating regime of the vending machine 17 determining the sub-type of the corresponding event using the numbers and letters of the description laid down in the protocol
event related to a sale made by the vending machine 17 determining the article sold using the numbers and letters of the description laid down in the protocol.

Sub-module 35 for interface DEX/UCS has a purpose that is identical to the purpose of sub-module 34 and it employs the same transceiver but with a fixed transmission rate (of 9600 bps).

In another embodiment of the present invention may be added peripheral logics supporting different types of electro-mechanical interfaces (covering the design of the logic of parallel interface 33) and the MICROMECH protocol (logic which is a combination of the above mentioned ones).

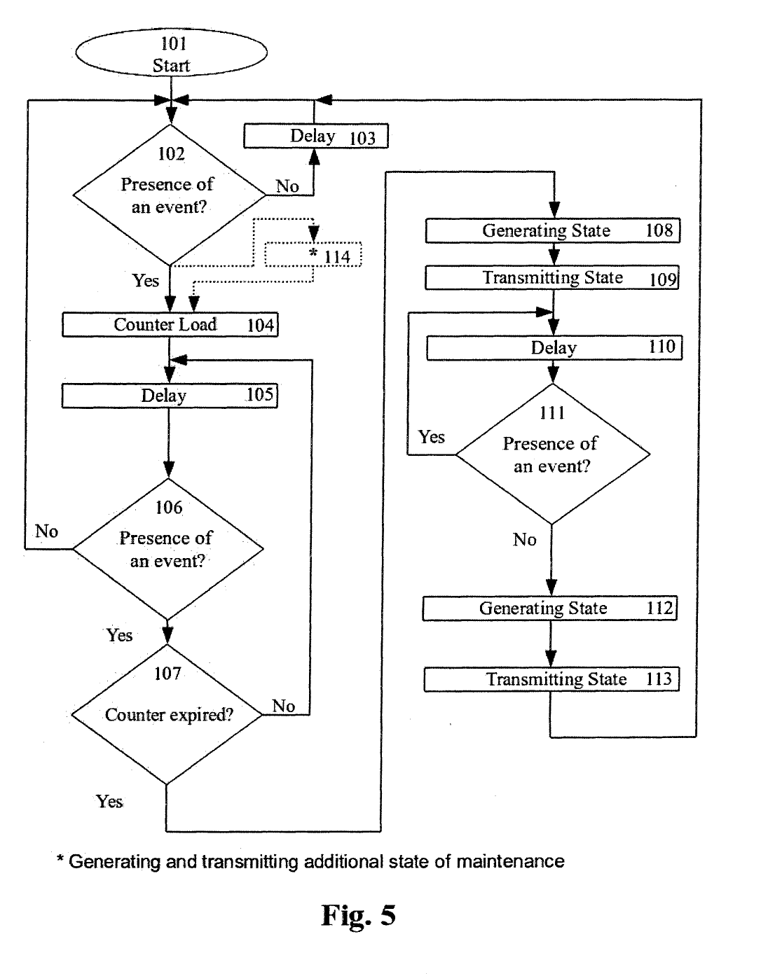

In FIG. 5 is described an algorithm 100 for generating of a state according to the invention. At step 101 the system is initialized and the starting states are normal technical state and operating state for the vending machine 17 and the payment system 18. At step 102 is performed a check up for the present of an event. If there is no event present, the method continues to step 103 at which a delay is performed. In view of the fact that the presence of a technical or operating event is recurring situation, these delays (103, 105, 110) have a value that is equal to the maximum recurrence time of 80 ms to 10 s (according to the communication protocol used). After the performance of the delay the algorithm returns to step 102. In case an event is present, step 104 follows at which a register counter is loaded. The value of the register counter 104 is equivalent to the time needed for transition from a normal state to an extraordinary state for the corresponding event (within 1-2 minutes). Performance of step 105 follows at which is executed a delay. At step 106 is carried out again a check up for the presence of an event. The lack of an event means that the definition for generating a state is not fulfilled and therefore the logic returns to step 102. The presence of an event directs the logic to step 107 at which is made a check up for an expired register counter and if the counter is not expired the algorithm returns to step 105. The expired register counter means that the state definition is fulfilled and at step 108 is generated the state whose definition is fulfilled after which at step 109 the information about the state is transmitted to the communication module 50. Step 110 follows at which is performed a delay, and step 111 at which is performed a reverse check up for lack of event. The presence of an event does not mean that the state is amended, and the algorithm returns back to step 110 while the lack of event determines the normalization of the technical/operating condition which happens at step 112. At step 113 the information about the normalization of the technical/operating condition is transmitted to the communication module 50 and the logic returns to the initial state 102.

The above mentioned algorithm 100 unifies the determination of the corresponding states and the sole exception is the additional state of technical condition as a sub-state of the operating regime. This state can be determined if the device is supplied with voltage which is not influenced by the service maintenance circuit breaker mounted as standard on the door of the vending machine 17. In this case opening of the door of the vending machine 17 will not discontinue the power supply of the device 1 and it will generate simultaneously events related to the technical condition of the vending machine 17 and the payment system 18. Then only once will be transmitted a state for technical service maintenance at the optional step 114 before the step 104 and the logic will continue according to the normal algorithm.

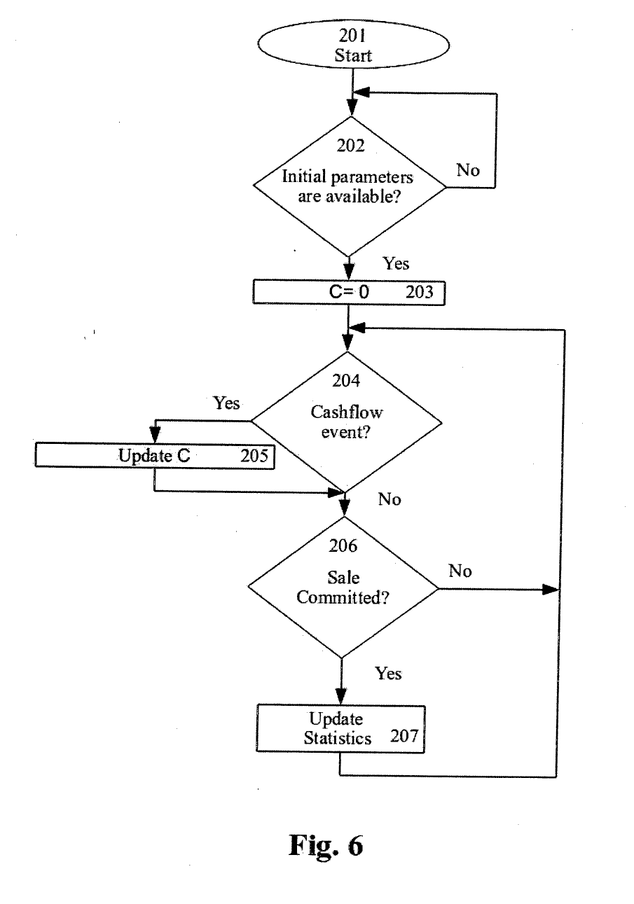

The events related to the revenues and sales of the vending machine 17 are handled according to the algorithm 200 described on FIG. 6.

At step 201 the system is initialized and at step 202 is awaited an event related to the initialization parameters which gives information about the adjustments of the payment system (value of coins/bank notes, multiplier, value of coins in the cartridge for paying back change and others) that are necessary for the correct calculation of the revenues and sales. At step 203 a variable C is generated with initial value of “0” which will provide information about the current credit in the system. At step 204 is watched for an event related to the revenues in the payment system. The presence of such an event should be reflected in the variable C which is updated at step 205. This event could be bidirectional—revenues entering the system as well as paying back of change. The logic remains in the state of awaiting at step 204 until an event occurs that is related to a sale made by the vending machine 17 for which is watched at step 206. Then in the corresponding statistics of the sales and revenues of the vending machine 207 is reflected one sale with its corresponding value and the logic returns to step 204.

In FIG. 7 is represented an algorithm for communication with an external peripheral device 15. The communication algorithm comprises a set of steps for initialization, transmitting of information regarding the condition and the current values of the sales and revenues to a remote server 407 by means of an external peripheral device 15, execution of a request for blocking the vending machine 17 received from the peripheral device 15, receiving of short text message (SMS) through the GSM modem of the peripheral device 15 and an additional set of steps for gaining access to the GPRS channel of the modem of the external peripheral device 15 (opening a connection to a server, sending data, receiving data and closing the connection) as well as an optional step for writing text messages on the display of the peripheral device 15.

The algorithm is based on communication of the type “master-slave” in which the device 1 is the master device and the peripheral device 15 is the slave device. The communication is initiated by the device 1 and the peripheral device 15 is obliged to respond to the received command within the time period of 1 second. The peripheral device 15 has no right to initiate a communication; it may only respond to received commands.

The algorithm for handling the communication on the part of the device 1 consists of the following steps:

After the starting step 601a variable S 702 is initialized with the following meaning:

S=0—basic state, normal communication without procedures for transmitting data to a remote server 407;
S=1—a request is sent to the peripheral device 15 for transmitting data to the remote server 407;
S=3—receipt of data from the remote server 407 through the peripheral device 15 is expected;
S=4—a request is sent to the peripheral device 15 for termination of the connection with the remote server 407.

After that step 703 follows at which the command POOL is transmitted and at 704 the passing of the time period of 1 second is awaited. Check up for presence of a valid response is performed at 705 and in case such a response is present a check up at 706 for the presence of a request for transmission of data is performed by the central logic 40. If such a request is not present or there is no valid response at step 706, step 703 follows again. The presence of a request for transmission of data at step 706 provokes an increase at 707 of the variable S by “1” and sending at 708 of a command for communication with the remote server in accordance with the value of S (1—command for initialization of connection, 2—command for sending data, 3—POOL and waiting for response from the remote server, 4—command for termination of the connection) and a counter register is loaded at 709 with duration of 2 minutes. At step 710 is performed the standard delay of 1 second and at step 711 is performed a check up for the presence of response. If there is no such response the initiation of connection is started from the beginning—step 708 and before that the variable S is loaded at 716 with an initial value “1”. The peripheral device 15 must respond positively or negatively to the command at 708 as a direct response to this command or as a response to the command POOL, within the duration of the loaded counter register at 709.

The valid responses according to the value of the variable S are:

S=1—the connection to the remote server is established;
S=2—data is transmitted to the remote server 407;
S=3—the response from the remote server is received, if there is such a response;
S=4—the connection to the remote server is terminated.

The check up for a valid response is performed at step 712 and, in case there is no such response, the method circulates within the cycle 714-715-710-711-712-714 until receiving such a response or until the loaded counter register 709 expires which is monitored at step 714. The expiration of the counter register 709 regardless of the value of the variable S is considered as unaccomplished communication and the communication is initiated from the beginning by setting the variable S into initial state S=1 at step 716 and return to step 708. The presence of a valid response at step 712 leads to a check up of the value of S at step 713. State corresponding to S=4 means a completed communication cycle with the remote server 407 and the algorithm returns to step 702. Value of S that is smaller than “4” means a partial execution of the communication cycle which brings the logic back to step 707 and with the increase of the value of S is initiated the execution of the next step of the transmission cycle.

Receiving of a short text message from the peripheral device 15 and its transmission to the master device 1 is performed in response to the command POOL at 703, 715 and is processed accordingly at steps 705, 712.

In another embodiment of the described invention the peripheral device 15 is given the opportunity to block the operation of the vending machine 17 using the device 1. In the algorithm of FIG. 7 this is reflected in steps 716-719 where the vending machine is blocked and unblocked according to the type of the response or the lack of response using the following logic:

lack of response—blocking of the vending machine 17 if it was not already blocked;
the response of the peripheral device 15 is acknowledgment—unblocking if it was blocked;
the response of the peripheral device 15 is BUSY—blocking of the vending machine 15 if it was not already blocked.

In its initial state the vending machine is considered to be not blocked.

Transmitting a command with a request to write text messages on the display of the peripheral device 15 is performed at steps 703 and 715 and in addition to the command POOL are added additional parameters as indication of such a request, the text message itself and the duration of its visualization. Such a request does not expect a particular acknowledgment, the visualization is not obligatory and it may not be executed by the peripheral device 15 at its own initiative. One example of this is a request at the time when the resource (display) of the peripheral device 15 is busy. In this case no visualization is executed but also no refusal of the execution is transmitted as a response of the master device 1.

Hereinafter will be described the operation of the device 1 for communicating with the vending machine 17 and payment systems 18.

The device 1 connects to the vending machine 17 and its associated payment systems 18 by means of attaching itself to the existing interface connecting them, and watching their communication.

The device 1 reduces the events obtained by watching the communication between the vending machine 17 and the payment systems 18 according to the different protocols and interfaces, to unified events according to which the following states could be determined relating to the technical condition and operating regime of the vending machine 17 and payment systems 18:

the vending machine 17 and payment systems 18 operate correctly when a normal communication exists between them;
the vending machine 17 does not operate when there is no communication therewith during a predetermined period of time, e.g. 6 minutes;
a particular payment system 18 does not operate when there is no communication therewith during a predetermined period of time, e.g. 6 minutes;
the vending machine 17 operates but it is technically not functional when the vending machine 17 does not allow the payment systems 18 to accept payments during a predetermined period of time, e.g. 15 minutes;
the vending machine 17 is in service maintenance process when the conditions of execution of step 114 of FIG. 5 are met;
any possible combinations of the above described states.

There are monitored as well one-time events related to the sales made by the vending machine and this is reflected in the statistics of the device 1 related to sales and revenues of the vending machine 17.

In case of transition from one state to another one or in case the state of the vending machine 17 and payment systems 18 were not changed during a predetermined period of time, e.g. 4 hours, the device 1 initiates a connection with the central server 15 and transmits the current state and the statistics of the sales and revenues.

In one embodiment of the present invention the peripheral device 15 is given the opportunity to initiate discontinuance of the operation of the vending machine 17 by means of sending a command to the device 1.

A general diagram of the implementation of the device 1 is represented in FIG. 8. A number of vending machines 401-405 having different payment systems are equipped with device 1. Each device monitors the operation of its associated vending machine and transmits the necessary data to the server 407 by means of the existing GSM network.

The present specification discloses exemplary embodiments of the method and device according to the invention which serve to explain the invention and in no way must be interpreted as limiting the scope of the invention which should be accorded the broadest protection in accordance with the accompanying claims.

1. A method for communicating with vending machine for selling goods and services (17) comprising detection of data, transmitting the data via a wireless network to a central location e.g. server (407) by means of modem, wherein the data is collected in a centralized manner for analysis; carrying out of analysis of the detected and transmitted data; extracting from the detected data an information about the availabilities in the vending machine (17), the availabilities in the payment systems (18) and the sales made by the vending machine (17) and the revenues in the payment systems (18); and performing of a remote control of the vending machine (17),
characterized in that
Detection of data is carried out by means of watching the communication between the vending machine (17) and its payment system or payment systems (18) without any intervention in this communication,
Carrying out of analysis of the detected and transmitted data includes determining of events and generating of states by means of unification of the meaning of the communication between the vending machine (17) and the payment systems (18) performed according to a multitude of standard protocols for communication between the vending machine and its payment systems;
Extracting from the analyzed data of information about the technical condition of the vending machine (17) and about the technical condition of the payment systems (18)
in that according to the said method is watched the communication between the vending machine (17) and the payment systems (18) performed according to the standard MBD and/or the standard Protocol A and/or the standard BDV and/or the standard Parallel Validator 12 VDC and/or the standard Parallel Validator 24 VDC and/or the auditing standard EVA DTS DDCMP and/or the auditing standard EVA-DTS DEX/UCS and/or the standard of the MICROMECH protocol and/or the standard of the protocol for electromechanical interface;
and in that the applying of the said method does not require any change in the existing logic of the vending machine (17).

2. The method for communicating with vending machine for selling goods and services (17) according to claim 1, characterized in that the following events are determined:
Events related to the technical condition of the vending machine (17);
Events related to the technical condition of the payment systems (18);
Events related to the operating regime of the vending machine (17);
One-time events related to revenues and sales made by the vending machine (17).

3. The method for communicating with vending machine for selling goods and services (17) according to claim 2, characterized in that the determining of events related to the technical condition of the vending machine (17) and/or events related to the technical condition of the payment systems (18) and/or events related to the operating regime of the vending machine (17) and/or combinations of the said events leads to generating of states.

4. The method for communicating with vending machine for selling goods and services (17) according to claim 2, characterized in that the one-time events related to a sale made by the vending machine (17) can be events related to revenues in the payment systems (18) and are determined in the following cases described in order of priority:
Command for paying back a given amount of money/coins if credit is present in the system and provided the credit exceeds the change paid back;
Command prohibiting to accept any money if credit is present;
Command to check up the condition of the cartridges of the coin accepting mechanism if credit is present.

5. The method for communicating with vending machine for selling goods and services (17) according to claim 1, characterized in that the onetime events related to the revenues in the payment systems (18) are defined for different types of payment systems.

6. The method for communicating with a vending machine for selling goods and services (17) according to claim 2, characterized in that the following cases are considered to be events related to the technical condition of the vending machine (17):
Detection of a low level of the power supply voltage of the payment systems (18);
Lack of continuous communication between the vending machine (17) and the payment systems (18) during a period of time from 80 milliseconds to 10 seconds.

7. The method for communicating with vending machine for selling goods and services (17) according to claim 2, characterized in that the following cases are considered to be events related to the technical condition of the payment systems (18):
Lack of response to commands sent by the payment systems (18).

8. The method for communicating with vending machine for selling goods and services (17) according to claim 2, characterized in that the following cases are considered to be events related to the operating regime of the vending machine (17):
Command prohibiting to accept money sent by the vending machine (17) to the payment systems (18);
Detection of a high level of the inhibiting channel of the Validator interface in case power supply is present if no credit is present.

9. The method for communicating with vending machine for selling goods and services (17) according to claim 1, characterized in that the detection of a high level of the inhibiting channel of the Validator interface in case power supply is present is considered to be an event related to the operating regime of the vending machine (17) if no credit is present and/or an event related to a sale made by the vending machine (17) if credit is present.

10. The method for communicating with vending machine for selling goods and services (17) according to claim 1, characterized in that the detection of a low level of the channels of the Validator interface in case power supply is present is considered to be an event related to the revenues in the payment system (18) and an event related to a technical problem in the payment system (18) if the said low level persists for a period of time preferably in the range of 100 to 1000 milliseconds.

11. The method for communicating with vending machine for selling goods and services (17) according to claim 10, characterized in that the said period of time is 500 milliseconds.

12. The method for communicating with vending machine for selling goods and services (17) according to claim 1, characterized in that the states may be normal and extraordinary states and an extraordinary state is generated in case of presence of an event that is repeated continuously during a predetermined period of time.

13. The method for communicating with vending machine for selling goods and services (17) according to claim 12, characterized in that the predetermined period of time upon expiring of which the corresponding event proceeds to an extraordinary state, is in the range of 1 to 20 minutes.

14. The method for communicating with vending machine for selling goods and services (17) according to claim 12, characterized in that the extraordinary state may be a combination of several states if several states are simultaneously present, the said states being provoked by identical or different events.

15. A device for communicating with vending machine for selling goods and services (17) comprising a receiving part comprising interface modules, a logical part comprising logic and a transmitting part comprising a modem, characterized in that:
The receiving part is built by a number of interface modules having the ability to work with different types and designs of vending machines (17) communicating with their payment systems (18) according to different standard protocols for communication between a vending machine and its payment systems, without any intervention in this communication;
The logical part is a unified logic built of a peripheral logical unit (30) having the ability on basis of data detected from the communication between the vending machine (17) and its payment systems (18) to define different types of events such as events relating to the technical condition of the vending machine (17), event relating to the technical condition of its payment systems (18), events relating to the operating regime of the vending machine (17) and one-time events relating to the sales made by the vending machine (17), and to transmit these events to a central logic (40) having the ability to process all events and on basis thereof to define 3 types of states such as states relating to the technical condition of the vending machine (17), states relating to the technical condition of the payment systems (18) and states relating to the operating regime of the vending machine (17) and to transmit these states to a communication module (50) for transmission to a central location, e.g. server (407), of the current states and current values of sales and revenues in case the central logic (4) has generated a change of the state, in case a predefined period of time has expired since the last transmission, e.g. 5 minutes to 8 hours, preferably 2 hours, in case a request has been received from an external peripheral device (15) and in case a short text message (SMS) with a predetermined content has been received, the transmission of the current values of sales and revenues being performed in the cases where the current states are transmitted.

16. A computer program product on an information medium containing instructions making a device (1) according to claim 15 to perform simultaneously and independently an algorithm for determination of events and for generating of states for establishing the technical condition of a vending machine (17) and its payment systems (18) and for establishing the normal functioning in an operating regime of the vending machine (17) and another algorithm for determination of one-time events for establishing the sales made by the vending machine (17) and the revenues in its payment systems (18) and for transmitting the results of the execution of both algorithms to a central location for analysis and optional sending back of a command to discontinue or restore the operation of the vending machine (17).
